(19) United States
(12) Patent Application Publication
(10) Pub. No.: US 2026/0147803 A1
(43) Pub. Date: May 28, 2026

(54) QUESTION ANSWERING METHOD AND APPARATUS, DEVICE AND MEDIUM

(71) Applicant: Beijing Zitiao Network Technology Co., Ltd., Beijing (CN)

(72) Inventors: Lu WANG, Beijing (CN); Keyu CHEN, Beijing (CN); Zhuorui WANG, Beijing (CN)

(21) Appl. No.: 19/401,089

(22) Filed: Nov. 25, 2025

(30) Foreign Application Priority Data
Nov. 25, 2024 (CN) 202411698125.6

(51) Int. Cl. G06F 16/3329; G06N 20/20

(52) U.S. Cl. CPC G06F 16/33295; G06N 20/20

(57) ABSTRACT

Embodiments of the disclosure discloses a question answering method and apparatus, a device and a medium. The method comprises: acquiring a current question, first historical question answering data, and a current chapter of a first script; inputting the current question, the first historical question answering data, and the current chapter into a dialog sub-model of a first model to obtain a current answer; adding the current question and the current answer to the first historical question answering data to obtain second historical question answering data; inputting the second historical question answering data and the current chapter into a determination sub-model of the first model to determine a completion result of a current task corresponding to the current chapter; generating a plot-related sentence by using the dialog sub-model based on the completion result of the current task, and presenting the plot-related sentence and the current answer.

### CROSS-REFERENCE TO RELATED APPLICATION(S

This application claims priority to Chinese Application No. 202411698125.6 filed November 25, 2024, the disclosure of which is incorporated herein by reference in its entirety.

### FIELD

The disclosure relates to the field of computer technologies, and particularly to a question answering method and apparatus, a device and a medium.

### BACKGROUND

With the rapid development in the field of deep learning, a question answering system may achieve question answering based on a language model.

### SUMMARY

Embodiments of the disclosure provide a question answering method and apparatus, a device and a medium.

Embodiments of the disclosure provide a question answering method, comprising: acquiring a current question, first historical question answering data, and a current chapter of a first script; inputting the current question, the first historical question answering data, and the current chapter into a dialog sub-model of the first model to obtain a current answer; adding the current question and the current answer to the first historical question answering data to obtain second historical question answering data; inputting the second historical question answering data and the current chapter into a determination sub-model of the first model to determine a completion result of a current task corresponding to the current chapter; generating a plot-related sentence by using the dialog sub-model based on the completion result of the current task, and presenting the plot-related sentence and the current answer.

Embodiments of the disclosure provide a question answering apparatus, comprising: an acquisition module configured to acquire a current question, first historical question answering data, and a current chapter of a first script; an answer module configured to input the current question, the first historical question answering data, and the current chapter into a dialog sub-model of the first model to obtain a current answer; an updating module configured to add the current question and the current answer to the first historical question answering data to obtain second historical question answering data; a determination module configured to input the second historical question answering data and the current chapter into a determination sub-model of the first model to determine a completion result of a current task corresponding to the current chapter; a plot module configured to generate a plot-related sentence by using the dialog sub-model based on the completion result of the current task, and present the plot-related sentence and the current answer.

Embodiments of the disclosure further provide an electronic device comprising: a processor; a memory for storing processor-executable instructions; the processor being used for reading the executable instructions from the memory and executing the instructions to implement the question answering method according to embodiments of the disclosure.

Embodiments of the disclosure further provide a computer-readable storage medium storing a computer program for executing the question answering method according to embodiments of the disclosure.

### BRIEF DESCRIPTION OF THE DRAWINGS

The above and other features, advantages and aspects of embodiments of the present disclosure will become more apparent with reference to the following specific implementations with reference to the drawings. Throughout the drawings, the same or like reference numerals denote the same or like elements. It should be appreciated that the drawings are schematic and that parts and elements are not necessarily drawn to scale.

FIG. 1 illustrates a flow chart of a question answering method according to an embodiment of the present disclosure;

FIG. 2 illustrates a schematic diagram of a question answering process according to an embodiment of the present disclosure;

FIG. 3 illustrates a flow chart of another question answering method according to an embodiment of the present disclosure;

FIG. 4 illustrates a schematic diagram of a model training process according to an embodiment of the present disclosure;

FIG. 5 illustrates a schematic diagram of a question answering apparatus according to an embodiment of the present disclosure;

FIG. 6 illustrates a schematic diagram of an electronic device according to an embodiment of the present disclosure.

### DETAILED DESCRIPTION OF EMBODIMENTS

A question answering model usually can only perform rigid question answering based on general knowledge. In a special question answering scenario, i.e., script-based dialog question answering, it is necessary to advance the plot forward upon performing question answering with the user according to the settings of the script, and it is difficult to satisfy plot consistency, task accuracy, linguistic coherence and plot guidance simultaneously in the prior art, and improvements need to be made.

Hereinafter, embodiments of the present disclosure will be described in more detail with reference to the accompanying drawings. While certain embodiments of the present disclosure have been illustrated in the accompanying drawings, it is to be understood that the present disclosure may be embodied in various forms and should not be construed as being limited to the embodiments set forth herein; rather, these embodiments are provided to enable the present disclosure to be understood more thoroughly and completely. It should be understood that the drawings and embodiments of the present disclosure are for illustrative purposes only and are not intended to limit the scope of the present disclosure.

It should be appreciated that steps described in a method embodiment of the present disclosure may be performed in a different order and/or in parallel. In addition, the method embodiment may include additional steps and/or omit the steps shown. The scope of the present disclosure is not limited in this regard.

As used herein, the term “include” and variations thereof are open-ended terms, i.e., mean “include, but not limited to”. The term “based on” means “based, at least in part, on”. The term “one embodiment” means “at least one embodiment”; the term “another embodiment” means “at least one further embodiment”; the term “some embodiments” means “at least some embodiments”. Relevant definitions of other terms will be given in the following depictions herein.

It needs to be appreciated that concepts such as “first” and “second” mentioned in the present disclosure are only used to distinguish between different devices, modules, or units and are not intended to limit the order of functions performed by these devices, modules or units or interdependence thereof.

It needs to be appreciated that the modifiers “one” or “a plurality of” mentioned in the present disclosure are intended to be illustrative and not restrictive, and those skilled in the art should understand that such modifiers should be understood as “one or more” unless the context clearly indicates otherwise.

The names of messages or information interacted between a plurality of devices in embodiments of the present disclosure are for illustrative purposes only and are not intended to limit the scope of such messages or information.

In order to solve the problem about an undesirable question answering effect in the relevant art, an embodiment of the present disclosure provides a question answering method, which will be described below with reference to specific embodiments.

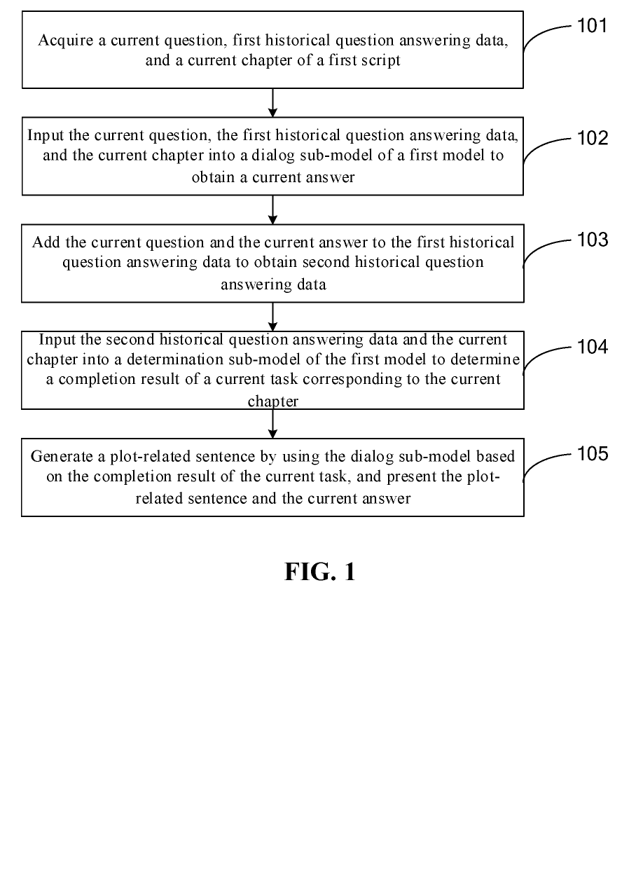

FIG. 1 illustrates a flow chart of a question answering method according to an embodiment of the present disclosure. The method may be performed by a question answering apparatus, wherein the apparatus may be implemented using software and/or hardware, and may be generally integrated in an electronic device. As shown in FIG. 1, the method comprises:

Step 101: a current question, first historical question answering data, and a current chapter of a first script are acquired.

The question answering method in the embodiment of the present disclosure is applicable to a script question answering scenario. Script question answering is also referred to as script dialog and may be a play method by which a user advances the plot according to settings of the script during a question answering process with a script dialog robot. In embodiments of the present disclosure, dialog and question answering convey the same meaning. Here the script dialog robot may be a computer program capable of simulating human dialog using a natural language, and implemented on the basis of a first model. The first model may be a model for conducting a dialog with the user as one of characters on the basis of the script and advancing the plot, and the first model may be a model based on a natural language processing technique and a natural language generation technique.

The first script may be a document on which the first model dialog is based, for example, the first script may be a novel, a movie and television drama script, etc. The first script may include content such as a story line of a story, characters’ dialog, an action description, a background description and an indication of interactions between characters, etc. and the content is arranged in a workflow manner. In an embodiment of the present disclosure, the first script may comprise a plurality of chapters, wherein each chapter comprises a plurality of tasks, i.e., each chapter has an explicit workflow, for example, task A occurs first, then task B occurs, etc., and each task has a corresponding completion condition. Once the user meets the completion condition, it is considered that the present task is completed, and the flow proceeds to the next task. If all the tasks in each chapter reach the completion condition, it is considered that the present chapter is completed， and the flow proceeds to the next chapter.

The current question may be a question currently input by the user. The first historical question answering data may be all question-answer pairs of a historical event preceding the current question, and the first historical question answering data may comprise a plurality of question-answer pairs.

Specifically, the question answering apparatus may firstly acquire the current question currently input by the user, and the first historical question answering data and the current chapter of the first script, wherein the current chapter may be a chapter where the user’s current question answering process is located in the first script. When the user initiates question answering, the current chapter is the first chapter.

Step 102: the current question, the first historical question answering data, and the current chapter are inputted into a dialog sub-model of the first model to obtain a current answer.

The first model in the embodiment of the present disclosure may comprise a dialog sub-model and a determination sub-model, wherein the dialog sub-model is used for the user playing a first character to perform question-answer with the user playing a second character. The first script may comprise a first character and a second character. The number of characters of the first script may be plural, and the first character and the second character are two different characters therein. The current answer may be content of a reply to the current question input by the user, and may be obtained by inference using the dialog sub-model. The current answer matches with a character persona of the first character and the plot of the first script. The character persona may be a summary of the personality of a character in the plot and the arc of the story, with unique characteristics. The plot may be a development process of the story involved in the first script, including a sequential order of events, causality and so on.

The dialog sub-model may be obtained by training using a character persona question-answer pair extracted based on the first script. The character persona question-answer pair may be obtained by rewriting based on character persona information of the first character and second character on the basis of a plot question-answer pair extracted from the first script. Since the dialog sub-model is obtained by training with training data associated with the plot and the character persona, for a question answering scenario of a certain character in a certain scenario, the answer of the dialog sub-model can not only comply with the character persona of the target character, but also match the plot of the first script, and improve character persona consistency and plot consistency upon question answering.

Specifically, after acquiring the current question, the first historical question answering data and the current chapter, the question answering apparatus may assemble the current question, the first historical question answering data and the current chapter according to a dialog prompt template to obtain a dialog prompt, input the dialog prompt into the first model, and perform inference and computation through the dialog sub-model of the first model to obtain the current answer corresponding to the current question.

The prompt template may be a template for configuring content and position included in a prompt, and is used to generate a prompt. The prompt may be used to trigger and guide the model to perform a specific character to generate a text or sentence segment having specific output content. The prompt may indicate a task that the model should perform to guide the model to generate specific content such as a text, an image or an audio. The dialog prompt template is used to generate a dialog prompt. The dialog prompt template comprises a plurality of placeholders for filling different information. The dialog prompt may be a prompt for guiding the dialog sub-model of the first model to generate the answer to the question.

Step 103: the current question and the current answer are added to the first historical question answering data to obtain second historical question answering data.

Wherein, the second historical question answering data may be obtained by updating the first historical question answering data according to the current question and current answer. After determining the current answer to the current question, the question answering apparatus may add the current question and current answer to the first historical question answering data for updating, to obtain the second historical question answering data.

Step 104: the second historical question answering data and the current chapter are inputted into a determination sub-model of the first model to determine a completion result of a current task corresponding to the current chapter.

In addition to the dialog sub-model, the first model further comprises a determination sub-model which is configured to determine a completion result of each task of each chapter, and update a plot progress according to the completion result. The first script comprises a plurality of chapters which each comprise a plurality of tasks. The determination sub-model may determine whether the current task of the current chapter has been completed after the answer is output each time in the question answering process, and update the plot progress according to the completion result to constantly advance the plot. The plot progress may be a specific situation about the development and advancement of an event in the story of the first script where the user is currently located. In the embodiment of the present disclosure, the plot progress indicates the chapter and task in the first script where the current question-answer pair of the user and the first model is located, i.e., a stage of the story where the user’s question-answer is located is reflected by the chapter and task.

Specifically, after determining the second historical question answering data, the question answering apparatus may assemble the second historical question answering data and the current chapter according to a determination prompt template to obtain a determination prompt, and input the determination prompt into the first model, perform inference and calculation via the determination sub-model of the first model to output a completion result of the current task of the current chapter. The completion result may comprise two types: completed and uncompleted. The determination prompt template is used to generate the determination prompt and comprises a plurality of placeholders for filling different information. The determination prompt may be a prompt for guiding the determination sub-model of the first model to determine whether the current task is completed and output the determination result.

Step 105: a plot-related sentence is generated by using the dialog sub-model based on the completion result of the current task, and presenting the plot-related sentence and the current answer.

Wherein, the plot-related sentence may be content related to the plot in the content of a reply to the current question input by the user. The plot-related sentence is used to correct and guide a dialog subject or a dialog direction to get close to the plot when the user’s question has not yet completed the current task and might deviate from the plot, or continue to advance the plot to enter next task when the user’s question has completed the current task. The dialog sub-model may generate the plot-related sentence according to the complete result of the current task.

Specifically, after determining the completion result of the current task, the question answering apparatus may input the second historical question answering data, the current chapter and the completion result of the current task into the dialog sub-model to output to obtain the plot-related sentence, then may present the plot-related sentence and the current answer to the user to enable the user to continue to input a question to have a dialog.

In some embodiments, the plot-related sentence comprises a plot-advancing sentence or a plot-guiding sentence. The generating a plot-related sentence using the dialog sub-model based on the completion result of the current task may comprise: if the completion result of the current task is “completed”, generating the plot-advancing sentence using the dialog sub-model; if the completion result of the current task is “uncompleted”, generating the plot-guiding sentence using the dialog sub-model.

The plot-related sentence may comprise two types of sentences: one is the plot-advancing sentence, and the other is the plot-guiding sentence. The plot-advancing sentence may be a sentence advancing the plot to enter the next task when the user’s question has completed the current task, and the plot-guiding sentence may be a sentence used to correct and guide a dialog subject or a dialog direction to get close to the plot when the user’s question has not yet completed the current task and might deviate from the plot.

Specifically, when the question answering apparatus generates the plot-related sentence using the dialog sub-model based on the completion result of the current task, if the completion result of the current task is “completed”, the plot-advancing sentence may be generated using the dialog sub-model, the plot-advancing sentence being related to the next task; if the completion result of the current task is “uncompleted”, the plot-guiding sentence may be generated using the dialog sub-model, the plot-guiding sentence being related to the circumstances of the current task. It is possible to, by generating the plot-related sentence according to the completion result of the task to guide the user to get close to the plot or continue to advance the plot, effectively enhance the plot-guiding capability, and prevent the user from deviating from the plot to enable the user to have the dialog focused on the plot direction.

Exemplarily, if the current question is “The weather is very good, isn’t it?”, the current answer may be “Yes, the weather is very good”, the completion result of the current task is “uncompleted” and the weather begins to be discussed departing from the plot, a plot-guiding sentence “but I’m a little tired and want to find a place to have a rest” may be generated to guide the user to complete the task of finding a place to have a rest.

In some embodiments, after the above step 105, the method may further comprise: updating the plot progress based on the completion result of the current task being “completed” until the plot progress reaches the last task of the last chapter of the first script.

After determining that the completion result of the current task is “completed”, the question answering apparatus may also update the plot progress, and then continue to acquire a questions input by the user to generate an answer and a plot-related sentence for question answering until the plot progress is updated to the last task of the last chapter of the first script, and if the completion result of the last task is also “completed”, the dialog will be stopped, or the user stops the current dialog actively.

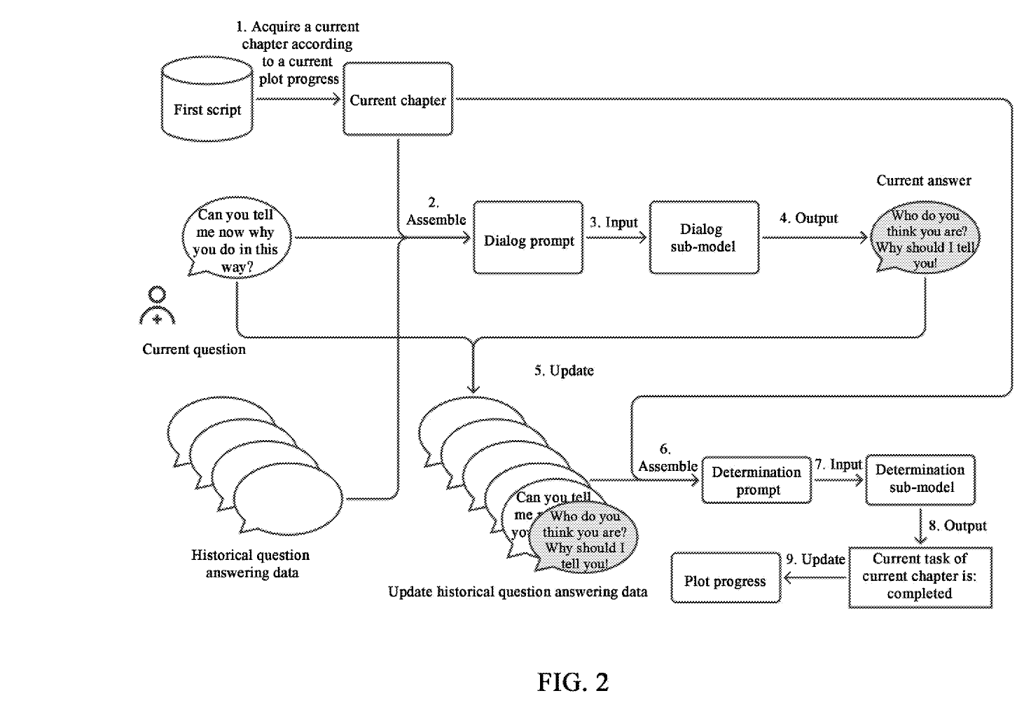

Exemplarily, FIG. 2 illustrates a schematic diagram of a question answering process according to an embodiment of the present disclosure. As shown in FIG. 2, the figure shows a question answering process implemented using a dialog sub-mode and a determination sub-model of the first model. The question answering process may comprise: acquiring a current chapter of a first script according to a current plot progress, and acquiring a current question input by a user, the current question being exemplified as “Can you tell me now why you do in this way?” in the figure; assembling a dialog prompt according to the current question, the current chapter and first historical question answering data, and inputting the dialog prompt into a dialog sub-model of the first model to output and obtain a current answer, the current answer being exemplified as “Who do you think you are? Why should I tell you!” in the figure; updating the first historical question answering data according to the current question and the current answer to obtain second historical question answering data; assembling a determination prompt according to the second historical question answering data and the current chapter, and inputting the determination prompt into a determination sub-model to output and obtain a completion result of the current task of the current chapter; if the completion result is “completed” as shown in the figure, updating the plot progress, generating a plot-advancing sentence using the dialog sub-model, and presenting the current answer and the plot-advancing sentence to the user to prompt the user to continue the dialog to advance the plot until the last task of the last chapter of the first script is executed, whereby the first script is completed.

In the question answering solution according to the embodiment of the present disclosure, a current question, first historical question answering data, and a current chapter of a first script are acquired; the current question, the first historical question answering data, and the current chapter are input into a dialog sub-model of the first model to obtain a current answer; the current question and the current answer are added to the first historical question answering data to obtain second historical question answering data; the second historical question answering data and the current chapter are input into a determination sub-model of the first model to determine a completion result of a current task corresponding to the current chapter; a plot-related sentence is generated using the dialog sub-model based on the completion result of the current task, and the plot-related sentence and the current answer are presented. According to the above technical solution, the answer to the question is determined according to the first script through the dialog sub-model of the first model, the completion result of the task is determined by the determination sub-model according to the historical question answering data and the first script, then the plot-related sentence is generated using the dialog sub-model according to the completion result of the task, and the answer and the plot-associated sentence are presented. In the manner of employing dual models of the first model, i.e., the dialog sub-model and the determination sub-model and the task workflow, it is possible to not only perform a dialog with the user according to the setting of the script, but also determine the completion situation of the task and thereby generate the plot-related sentence according to the completion situation of the task to guide the user to get close to the plot or continue to advance the plot. As for the question answering scenario of the script, plot consistency, task accuracy, linguistic coherence and plot guidance are all effectively improved so that the user’s script dialog effect is enhanced.

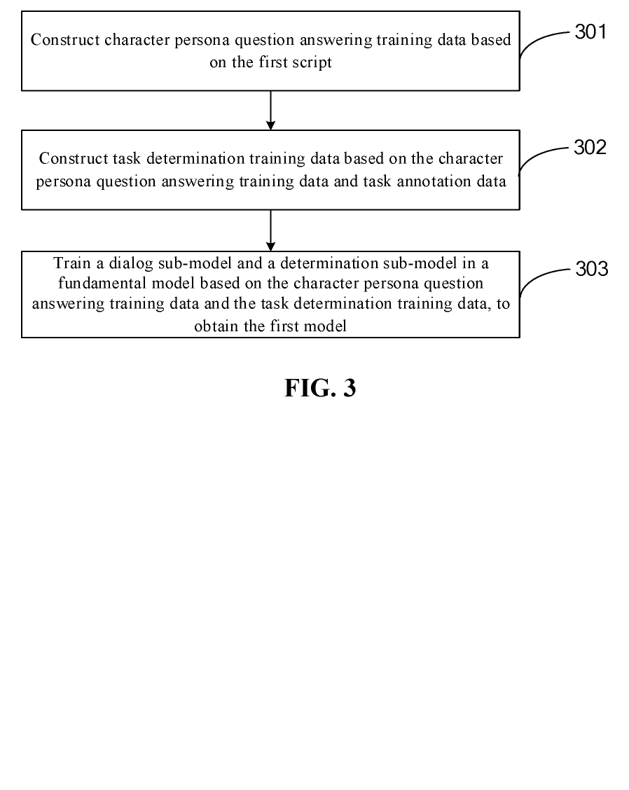

Exemplarily, FIG. 3 is a schematic flow chart of another question answering method according to an embodiment of the present disclosure. As shown in FIG. 3, in a feasible implementation, a first model is determined in the following way:

Step 301: character persona question answering training data are constructed based on a first script.

Wherein, the character persona question answering training data may be training data for training a dialog sub-model in the first model. The character personal question answering training data may comprise a plurality of character personal question-answer pairs which each are related to a plot involved by the first script, and comply with character persona information of a character in the first script and a unique feature of the character in the script.

Specifically, the question answering apparatus may construct the character persona question answering training data via an information extraction model based on the first script. The information extraction model may be language model based on deep learning and a natural language processing technology. Specifically, a plot question-answer pair and character persona information may be extracted according to the first script. The character persona information may comprise character persona information of the above first character and second character. The character persona information may be information obtained by summarizing the character’s personality in a plot and the arc of the story. The character persona information may be preset in the first script, or extracted according to the first script; the plot question-answer pair may be obtained by input the first script chapter by chapter into the information extraction model; then, the plot question-answer pair and the character persona information may be input into an information rewriting model to obtain a plurality of character personal question-answer pairs. The information rewriting model may be a model for rewriting the question-answer pairs based on the character persona information, and its specific type is not limited. The character persona question-answer pairs may be question-answer pairs complying with the character persona information and obtained by rewriting the plot question-answer pairs. The plot question-answer pairs here comply with the character persona information of the first character and second character.

In some embodiments, the constructing character persona question answering training data based on a first script may comprise: constructing a first prompt corresponding to a first character and a second prompt corresponding to a second character based on the first script; using a first model controlled by the first prompt and a second model controlled by the second prompt for question answering, and extracting question-answer pairs and determining them as the character persona question answering training data.

The first model may be a model that plays a first character, and the second model may be a model that plays a second character. Since the user plays the second character, the second model is also a model that plays the user, and the first model and the second model may use the same model or two different models. In the embodiment of the present disclosure, the two models are used alternatingly for the dialog to generate the character persona question answering training data. The first prompt is used for controlling the first model to advance the plot according to the first script and play the first character to have a dialog with the second character, i.e., the first prompt is used for controlling the dialog globally to complete the dialog according to the first script; the second prompt is used for controlling the second model to play the second character to have a dialog with the first character, and the second prompt comprises a plurality of pieces of character persona information corresponding to the second character. The plurality of pieces of character persona information may be set according to actual situations. A stylized dialog between characters is generated according to the constraints of the character person information. Since the user plays the second character, and various random situations may occur in the dialog for multiple users, the diversity of the dialog is controlled and the dialog robustness is enhanced by setting the plurality of pieces of character persona information of the second character to add random factors in the dialog.

Specifically, upon constructing the character persona question answering training data based on the first script, the question answering apparatus may firstly construct the first prompt of the first character and the second prompt of the second character based on the first script, then may input the first prompt into the first model to generate dialog content of the first character, and input the second prompt into the second model to generate dialog content of the second character, and alternately use the two models to perform multiple rounds of dialog or multiple rounds of question answering until the first script is completed, and then may change the character persona information of the second character to perform one more dialog until all the character persona information of the second character is applied, and extract and combine all question-answer pairs to obtain the character persona question answering training data.

Optionally, the character persona question answering training data may be manually constructed by supervised fine tuning.

In the above solution, it is possible to, in a model-inter-related manner on the basis of the first script, construct the character persona question answering training data quickly and accurately, improve the efficiency and robustness in constructing the training data and help improve the efficiency of subsequent model training.

Step 302: task determination training data are constructed based on the character persona question answering training data and task annotation data.

The task annotation data may be data which is manually annotated for partial question-answer pairs of the character persona training data according to the first script and is about whether the task is completed, for example, whether each question-answer pair completes a corresponding task of a corresponding chapter is annotated manually for one third of question-answer pairs in the character persona question answering training data. The task determination training date may be training data for training the determination sub-model in the first model, and may comprise a plurality of question-answer pairs and a completion result of a task corresponding to each question-answer pair, i.e., one question-answer pair and a completion result of a task under a corresponding chapter are one piece of data. The task determination training data comprise a plurality of pieces of data.

Specifically, after constructing the character persona question answering training data, the question answering apparatus may acquire the task annotation data, then first perform preliminary training on the determination sub-model of a fundamental model based on partial question-answer pairs in the character persona question answering training data corresponding to the task annotation data, then input remaining question-answer pairs in the character persona question answering training data and the first script into the preliminarily-trained determination sub-model to obtain the completion result of the task corresponding to each question-answer pair, and determine the question-answer pairs in the character persona question answering training data and the completion results of the corresponding tasks as the task determination training data.

Here the task annotation data is introduced to construct the task determination training data. Since the task annotation data is high-quality training data, it is ensured that the determination sub-model continuously learns task determination capabilities while maintaining high levels of determination capability and knowledge understanding capability during training.

Step 303: the dialog sub-model and determination sub-model in the fundamental model are trained based on the character persona question answering training data and the task determination training data, to obtain the first model.

Specifically, after determining the character persona question answering training data and the task determination training data, the question answering apparatus may train the fundamental model based on the character persona question answering training data and the task determination training data, and during the training, train the dialog sub-model of the fundamental model based on the character persona question answering training data, and train the determination sub-model based on the task determination training data. Furthermore, the training of the two sub-models is integrated until the two sub-models both satisfy a convergence condition, and then the duly-trained fundamental model is determined as the first model.

It may be appreciated that the training of the first model and the above question answering based on the first model in the embodiment of the present disclosure may be performed by one electronic device, or each performed by two electronic devices.

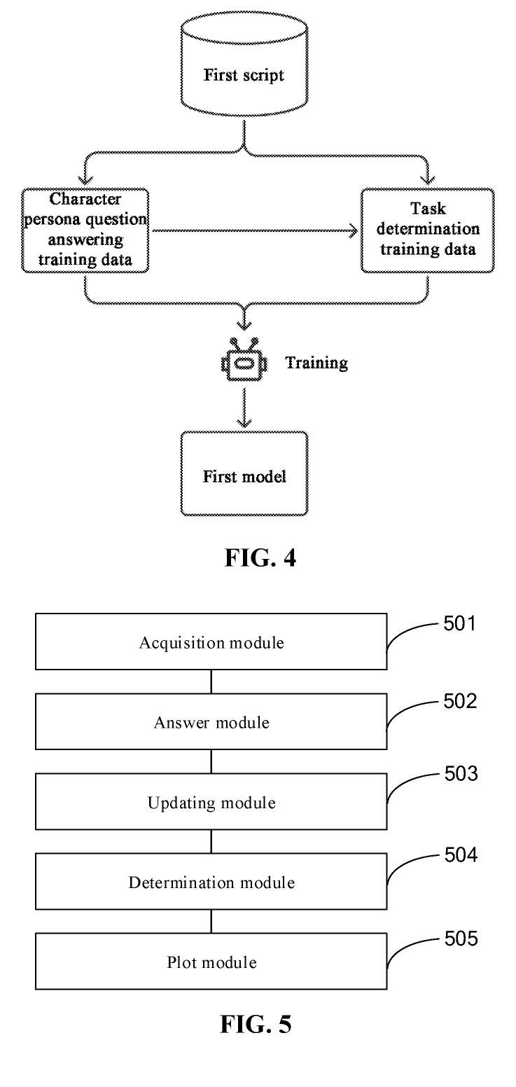

As an example, FIG. 4 illustrates a schematic diagram of a model training process according to an embodiment of the present disclosure. In the figure, the training process of a first model may be constructing character persona question answering training data based on a first script, constructing task determination training data based on the character persona question answering training data and the first script, and training a fundamental model based on the character persona question answering training data and the task determination training data to obtain a first model.

In the above solution, character persona question answering training data is constructed based on a first script; task determination training data is constructed based on the character persona question answering training data and task annotation data; the dialog sub-model and determination sub-model in the fundamental model are trained based on the character persona question answering training data and the task determination training data, to obtain the first model. Since the first model is trained based on the character persona question answering training data constructed based on the plot of the first script and character persona information, and the task determination training data, the first model has a character persona maintaining capability, a knowledge understanding capability, a task determining capability and a plot guiding capability. The first model and the user-implemented script dialog process can not only comply with the character persona of the played character, but also match the plot of the first script, but also advance the plot, effectively improve multi-dimensional capabilities of the model such as the character persona consistency, plot consistency, task accuracy, language coherence, plot guidance and plot richness upon question answering, so that the user can obtain a better question answering experience effect in a special scenario based on the script dialog.

Regarding drawbacks in question answering based on general knowledge in aspects such as multiple rounds of question-answer, character persona maintenance, plot advancement and plot progress determination in the prior art, the solution provides a solution improving the script dialog capability or script question answering capability, and the script dialog effect is effectively improved by using the dual models and the task workflow to determine whether the task is completed.

The present solution can achieve the following advantageous effects based on a script dialog robot based on the first model:

1. Multiple rounds of dialogs: the user and the script dialog robot can jointly advance the plot in the multiple rounds of dialog; the first model can understand historical dialogs and make a proper reply, so the capability of the first model for multiple rounds of dialogs is indispensable.

2. Character persona maintenance: the script dialog robot can still play a preset character to chat with the user, so the first model can have a distinct character persona feature upon replying to the user, and enhance the user’s sense of immersion. This may be specifically divided into two aspects: one is that the script dialog robot maintains the persona of the character played by itself, and the other is that the user also plays a character to chat with the script dialog robot. Therefore, the script dialog robot can also sense and maintain the relationship between the character played by the user and the character played by the script dialog robot itself.

3. Advancing the plot: the script dialog robot can have a capability of guiding the user to advance the plot; one the one hand, when the user’s chat deviates from the set task of the script, the first model can properly guide the user to continue to advance the plot; on the other hand, when the user proceeds according to the set task of the script, the first model can make a response complying with the setting of the plot to help the user to acquire information and let the user continue to advance the plot actively.

4. Determination of the plot progress: upon different plot progress, the first model can make different response, or put it in another way, upon different plot progress, the task targets of the plot dialog robot are different; the first model can accurately determine the current plot progress, thereby making a proper reply to the user’s speech.

FIG. 5 illustrates a schematic diagram of a question answering apparatus according to an embodiment of the present disclosure. The apparatus may be implemented by software and/or hardware, or generally integrated in an electronic device. As shown in FIG. 5, the apparatus comprises:

an acquisition module 501 configured to acquire a current question, first historical question answering data, and a current chapter of a first script;

an answer module 502 configured to input the current question, the first historical question answering data, and the current chapter into a dialog sub-model of the first model to obtain a current answer;

an updating module 503 configured to add the current question and the current answer to the first historical question answering data to obtain second historical question answering data;

a determination module 504 configured to input the second historical question answering data and the current chapter into a determination sub-model of the first model to determine a completion result of a current task corresponding to the current chapter;

a plot module 505 configured to generate a plot-related sentence using the dialog sub-model based on the completion result of the current task, and present the plot-related sentence and the current answer.

Optionally, the first script comprises a first character and a second character, the dialog sub-model is used for playing the first character to perform question-answer with the user playing the second character, and the current answer matches the character persona of the first character and the plot of the first script.

Optionally, the first script comprises a plurality of chapters which each comprises a plurality of tasks;

the determination sub-model is configured to determine a completion result of each task of the current chapter, and update a plot progress according to the completion result, the plot progress indicating the chapter and task in the first script where a current question-answer pair of the user and the first model is located.

Optionally, the apparatus may further comprise a model training model comprising:

a first unit configured to construct character persona question answering training data based on the first script;

a second unit configured to construct task determination training data based on the character persona question answering training data and task annotation data;

a third unit configured to train a dialog sub-model and a determination sub-model in a fundamental model based on the character persona question answering training data and the task determination training data, to obtain the first model.

Optionally, the first unit is configured to:

construct a first prompt corresponding to the first character and a second prompt corresponding to the second character based on the first script;

use a first model controlled by the first prompt and a second model controlled by the second prompt for question answering, and extracting question-answer pairs and determining them as the character persona question answering training data.

Optionally, the first prompt is used for controlling the first model to advance the plot according to the first script and play the first character to have a dialog with the second character;

the second prompt is used for controlling the second model to play the second character to have a dialog with the first character, and the second prompt comprises a plurality of pieces of character persona information corresponding to the second character.

Optionally, the plot-related sentence comprises a plot-advancing sentence and a plot-guiding sentence, and the plot module 505 is configured to:

if the completion result of the current task is “completed”, generate the plot-advancing sentence using the dialog sub-model;

if the completion result of the current task is “uncompleted”, generate the plot-guiding sentence using the dialog sub-model.

Optionally, the apparatus further comprises a plot-updating module configured to:

update the plot progress based on the “completed” completion result of the current task until the plot progress reaches the last task of the last chapter of the first script.

The question answering apparatus according to the embodiment of the present disclosure may execute a question answering method according to any embodiment of the present disclosure, and has functional modules and advantageous effects corresponding to the execution of the method.

Embodiments of the present disclosure further provide a computer program product comprising a computer program/instructions that, when executed by a processor, implement the question answering method according to any embodiments of the present disclosure.

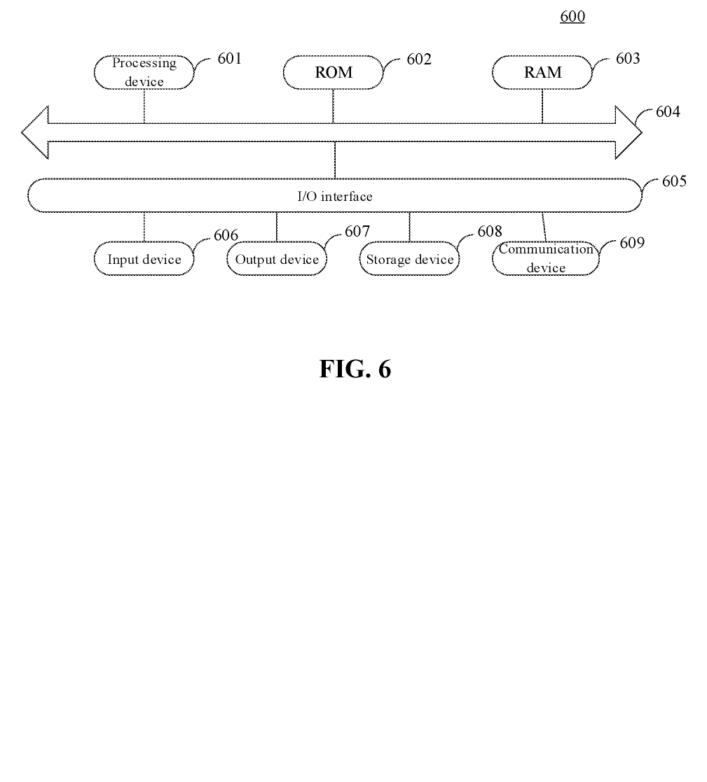

FIG. 6 shows a schematic structural diagram of an electronic device according to an embodiment of the present disclosure.

Reference is specifically made to FIG. 6 which illustrates a schematic diagram of an electronic device 600 adapted to implement embodiments of the present disclosure. The electronic device 600 in embodiments of the present disclosure may include, but not limited to, mobile terminals such as mobile phones, notebook computers, digital broadcast receivers, Personal Digital Assistants (PDAs), Tablet Computers (Portable Android Devices, PADs), Portable Multimedia Players (PMPs), in-vehicle terminals (e.g., in-vehicle navigation terminals), etc. and fixed terminals such as digital TVs, desktop computers, etc. The electronic device shown in FIG. 6 is merely an example and should not impose any limitations on the functionality and scope of use of embodiments of the present disclosure.

As shown in FIG. 6, the electronic device 600 may comprise a processing device (e.g., a central processing unit, a graphics processor, etc.) 601 that may perform various suitable acts and processes in accordance with a program stored in a Read Only Memory (ROM) 602 or a program loaded from a storage device 608 into a Random Access Memory (RAM) 603. In the RAM 603, various programs and data needed by the operation of the electronic device 600 are also stored. The processing device 601, the ROM 602, and the RAM 603 are connected to one another via a bus 604. An input/output (I/O) interface 605 is also coupled to the bus 604.

In general, the following devices may be connected to the I/O interface 605: an input device 606 including, for example, a touch screen, a touch pad, a keyboard, a mouse, a camera, a microphone, an accelerometer, a gyroscope, etc.; an output device 607 including, for example, a Liquid Crystal Display (LCD), a speaker, a vibrator, etc.; a storage device 608 including, for example, a magnetic tape, a hard disk, etc.; and a communication device 609. The communication device 609 may allow the electronic device 600 to communicate in a wireless or wired manner with other devices to exchange data. While FIG. 6 illustrates the electronic device 600 having various devices, it is to be understood that not all illustrated devices are required to be implemented or provided. More or fewer devices may alternatively be implemented or provided.

Especially, according to embodiments of the present disclosure, the processes described above with reference to flow charts may be implemented as computer software programs. For example, embodiments of the present disclosure comprise a computer program product comprising a computer program carried on a non-transitory computer-readable medium, the computer program comprising program code for performing the method illustrated by the flow charts, thereby implementing the above image stylization processing method. In such embodiments, the computer program may be downloaded and installed from a network via the communication device 609, or installed from the storage device 608, or installed from the ROM 602. When the computer program is executed by the processing device 601, the above-described functions defined in the method of the embodiment of the present disclosure are performed.

It is appreciated that the computer-readable medium described above in the present disclosure may be either a computer-readable signal medium or a computer-readable storage medium, or any combination of the two. The computer-readable storage medium may be, for example but not limited to, an electronic, magnetic, optical, electromagnetic, infrared, or semiconductor system, apparatus, or device, or a combination of any of the above. More specific examples of the computer-readable storage medium may comprise, but are not limited to: an electrical connection having one or more wires, a portable computer magnetic disk, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program that may be used by or in conjunction with an instruction execution system, apparatus, or device. In the present disclosure, the computer-readable signal medium may comprise a data signal embodied in baseband or propagated as part of a carrier carrying computer-readable program code. Such propagated data signals may take many forms, including but not limited to, electromagnetic signals, optical signals, or any suitable combinations thereof. The computer-readable signal medium may also be any computer-readable medium other than a computer-readable storage medium that may send, propagate, or transport the program for use by or for use in conjunction with the instruction execution system, apparatus, or device. The program code contained on the computer-readable medium may be transmitted with any suitable medium including, but not limited to: electrical wire, optic cable, RF (radio frequency), and the like, or any suitable combinations thereof.

In some embodiments, the client and server may communicate using any currently known or future-developed network protocol, such as HTTP (HyperText Transfer Protocol), and may be interconnected with any form or medium of digital data communication (e.g., a communication network). Examples of the communication network comprise Local Area Networks (“LANs”), Wide Area Networks (“WANs”), the Interne, and peer-to-peer networks (e.g., ad hoc peer-to-peer networks), as well as any currently known or future-developed networks.

The computer readable medium may be contained in the above-described electronic device; it may also be present separately and not installed into the electronic device.

The computer-readable medium carries one or more programs that, when executed by an electronic device, cause the electronic device to: acquire a current question, first historical question answering data, and a current chapter of a first script; input the current question, the first historical question answering data, and the current chapter into a dialog sub-model of the first model to obtain a current answer; add the current question and the current answer to the first historical question answering data to obtain second historical question answering data; input the second historical question answering data and the current chapter into a determination sub-model of the first model to determine a completion result of a current task corresponding to the current chapter; generate a plot-related sentence using the dialog sub-model based on the completion result of the current task, and present the plot-related sentence and the current answer.

The computer program code for carrying out operations of the present disclosure may be written in one or more programming languages or combinations thereof. The programming languages include, but not limited to, object-oriented programming languages, such as Java, Smalltalk, C++, and conventional procedural programming languages, such as the “C” language or similar programming languages. The program code may be executed entirely on the user’s computer, executed partly on the user’s computer, executed as a stand-alone software package, executed partly on the user’s computer and partly on a remote computer, or executed entirely on the remote computer or a server. In the case of the remote computer, the remote computer may be connected to the user’s computer through any type of network, including a local area network (LAN) or a wide area network (WAN), or it may be connected to an external computer (e.g., connected through the Internet using an Internet service provider).

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or operations, or combinations of special-purpose hardware and computer instructions.

The units described in connection with the embodiments disclosed herein may be implemented in a software or hardware manner. The names of the units do not constitute limitations of the units themselves in a certain case.

The functions described herein above may be performed, at least in part, by one or more hardware logic constituent elements. For example, without limitation, exemplary types of hardware logic constituent elements that may be used comprise: a Field Programmable Gate Array (FPGA), an Application Specific Integrated Circuits (ASIC), an Application Specific Standard Products (ASSP), a Systems On Chip (SOC), a Complex Programmable Logic Device (CPLD), and so on.

In the context of the present disclosure, the machine-readable medium may be a tangible medium that may contain or store a program for use by or for use in conjunction with an instruction execution system, apparatus, or device. The machine-readable medium may be a machine-readable signal medium or a machine-readable storage medium. The machine-readable medium may comprise, but is not limited to, an electronic, magnetic, optical, electromagnetic, infrared, or semiconductor system, apparatus, or device, or any suitable combinations thereof. More specific examples of the machine-readable storage medium would comprise an electrical connection based on one or more wires, a portable computer diskette, a hard disk, a random access memory (RAM), a read-only memory (ROM), an erasable programmable read-only memory (EPROM or Flash memory), an optical fiber, a compact disc read-only memory (CD-ROM), an optical storage device, a magnetic storage device, or any suitable combination thereof.

It is to be understood that, before the technical solutions disclosed in the embodiments of the present disclosure are used, a user should be informed of a type, a use range, a use scenario, etc. of personal information involved in the present disclosure and authorization should be obtained from the user in an appropriate manner according to relevant laws and regulations.

The foregoing description is only illustrative of preferred embodiments of the present disclosure and of the principles of the technology employed. It will be appreciated by those skilled in the art that the scope of the present disclosure is not limited to technical solutions formed by specific combinations of the above technical features, and meanwhile covers other technical solutions formed by any combinations of the above technical features or other equivalent features, for example, technical solutions formed by mutual replacement of the above features and technical features having similar functions disclosed in (not limited to) the present disclosure, without departing from the concept disclosed above.

In addition, while operations are depicted in a particular order, this should not be understood as requiring that such operations are performed in the particular order shown or in sequential order. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in the context of a single implementation may also be implemented in multiple implementations separately or in any suitable sub-combination.

Although the subject matter has been described in language specific to structural features and/or methodological actions, it should be understood that the subject matters specified in the appended claims are not limited to the specific features or actions described above. Rather, the specific features and actions described above are disclosed as example forms of implementing the claims.

I/We claim:

1. A question answering method, comprising:
acquiring a current question, first historical question answering data, and a current chapter of a first script;
inputting the current question, the first historical question answering data, and the current chapter into a dialog sub-model of a first model to obtain a current answer;
adding the current question and the current answer to the first historical question answering data to obtain second historical question answering data;
inputting the second historical question answering data and the current chapter into a determination sub-model of the first model to determine a completion result of a current task corresponding to the current chapter; and
generating a plot-related sentence by using the dialog sub-model based on the completion result of the current task, and presenting the plot-related sentence and the current answer.

2. The method according to claim 1, wherein the first script comprises a first character and a second character, the dialog sub-model is configured for a user playing the first character to perform question-answer with a user playing the second character, and the current answer matches a character persona of the first character and a plot of the first script.

3. The method according to claim 1, wherein the first script comprises a plurality of chapters which each comprises a plurality of tasks; and
the determination sub-model is configured to determine a completion result of each task of each chapter, and update a plot progress according to the completion result, and the plot progress indicates a chapter and a task in the first script where a current question-answer pair between the user and the first model is located.

4. The method according to claim 1, wherein the first model is determined in the following way:
constructing character persona question answering training data based on the first script;
constructing task determination training data based on the character persona question answering training data and task annotation data; and
training a dialog sub-model and a determination sub-model in a fundamental model based on the character persona question answering training data and the task determination training data to obtain the first model.

5. The method according to claim 4, wherein constructing the character persona question answering training data based on the first script comprises:
constructing a first prompt corresponding to the first character and a second prompt corresponding to the second character based on the first script; and
performing, based on a first model controlled by the first prompt and a second model controlled by the second prompt, question answering, and extracting question-answer pairs and determining them as the character persona question answering training data.

6. The method according to claim 5, wherein the first prompt is used for controlling the first model to advance a plot according to the first script and play the first character to have a dialog with the second character; and
the second prompt is used for controlling the second model to play the second character to have a dialog with the first character, and the second prompt comprises a plurality of pieces of character persona information corresponding to the second character.

7. The method according to claim 1, wherein the plot-related sentence comprises a plot-advancing sentence or a plot-guiding sentence, and generating the plot-related sentence by using the dialog sub-model based on the completion result of the current task comprises:
in response to the completion result of the current task being completed, generating the plot-advancing sentence by using the dialog sub-model; or
in response to the completion result of the current task being uncompleted, generating the plot-guiding sentence by using the dialog sub-model.

8. The method according to claim 1, further comprising:
updating the plot progress based on the completion result of the current task being completed until the plot progress reaches the last task of the last chapter of the first script.

9. An electronic device, comprising:
one or more processors;
a storage device for storing one or more programs, wherein,
the one or more programs, when executed by the one or more processors, cause the one or more processors to:
acquire a current question, first historical question answering data, and a current chapter of a first script;
input the current question, the first historical question answering data, and the current chapter into a dialog sub-model of a first model to obtain a current answer;
add the current question and the current answer to the first historical question answering data to obtain second historical question answering data;
input the second historical question answering data and the current chapter into a determination sub-model of the first model to determine a completion result of a current task corresponding to the current chapter; and
generate a plot-related sentence by using the dialog sub-model based on the completion result of the current task, and present the plot-related sentence and the current answer.

10. The device according to claim 9, wherein the first script comprises a first character and a second character, the dialog sub-model is configured a user playing the first character to perform question-answer with a user playing the second character for, and the current answer matches a character persona of the first character and a plot of the first script.

11. The device according to claim 9, wherein the first script comprises a plurality of chapters which each comprises a plurality of tasks; and
the determination sub-model is configured to determine a completion result of each task of each chapter, and update a plot progress according to the completion result, the plot progress indicating a chapter and a task in the first script at where a current question-answer pair of the user and the first model is located.

12. The device according to claim 9, wherein the first model is determined in the following way:
constructing character persona question answering training data based on the first script;
constructing task determination training data based on the character persona question answering training data and task annotation data; and
training a dialog sub-model and a determination sub-model in a fundamental model based on the character persona question answering training data and the task determination training data to obtain the first model.

13. The device according to claim 12, wherein the one or more programs causing the one or more processors to construct the character persona question answering training data based on the first script comprise instructions to:
construct a first prompt corresponding to the first character and a second prompt corresponding to the second character based on the first script; and
perform, based on a first model controlled by the first prompt and a second model controlled by the second prompt, question answering, and extract question-answer pairs and determine them as the character persona question answering training data.

14. The device according to claim 13, wherein the first prompt is used for controlling the first model to advance a plot according to the first script and play the first character to have a dialog with the second character; and
the second prompt is used for controlling the second model to play the second character to have a dialog with the first character, and the second prompt comprises a plurality of pieces of character persona information corresponding to the second character.

15. The device according to claim 9, wherein the plot-related sentence comprises a plot-advancing sentence or a plot-guiding sentence, and the one or more programs causing the one or more processors generate the plot-related sentence by using the dialog sub-model based on the completion result of the current task comprise instructions to:
in response to the completion result of the current task being completed, generate the plot-advancing sentence by using the dialog sub-model; or
in response to the completion result of the current task is uncompleted, generate the plot-guiding sentence by using the dialog sub-model.

16. The device according to claim 9, the one or more programs further causing the one or more processors to:
update the plot progress based on the completion result of the current task being completed until the plot progress reaches the last task of the last chapter of the first script.

17. A non-transitory storage medium containing computer-executable instructions, wherein the computer-executable instructions, when executed by one or more computer processors, are used to cause the one or more computer processors to:
acquire a current question, first historical question answering data, and a current chapter of a first script;
input the current question, the first historical question answering data, and the current chapter into a dialog sub-model of a first model to obtain a current answer;
add the current question and the current answer to the first historical question answering data to obtain second historical question answering data;
input the second historical question answering data and the current chapter into a determination sub-model of the first model to determine a completion result of a current task corresponding to the current chapter; and
generate a plot-related sentence by using the dialog sub-model based on the completion result of the current task, and present the plot-related sentence and the current answer.

18. The non-transitory storage medium according to claim 17, wherein the first script comprises a first character and a second character, the dialog sub-model is configured for a user playing the first character to perform question-answer with a user playing the second character, and the current answer matches a character persona of the first character and a plot of the first script.

19. The non-transitory storage medium according to claim 17, wherein the first script comprises a plurality of chapters which each comprises a plurality of tasks; and
the determination sub-model is configured to determine a completion result of each task of each chapter, and update a plot progress according to the completion result, the plot progress indicating a chapter and a task in the first script at where a current question-answer pair of the user and the first model is located.

20. The non-transitory storage medium according to claim 17, wherein the first model is determined in the following way:
constructing character persona question answering training data based on the first script;
constructing task determination training data based on the character persona question answering training data and task annotation data; and
training a dialog sub-model and a determination sub-model in a fundamental model based on the character persona question answering training data and the task determination training data to obtain the first model.
